(19) United States
(12) Patent Application Publication
(10) Pub. No.: US 2008/0139303 A1
(43) Pub. Date: Jun. 12, 2008

(54) SYSTEM FOR ELECTRONICALLY HANDLING A MARKER

(76) Inventor: Thompson B. Patterson, Nashville, TN (US)

Correspondence Address: Hiscock & Barclay, LLP, One Park Place, 300 South State Street, Syracuse, NY, 13202-2078, US

(21) Appl. No.: 11/949,890

(22) Filed: Dec. 4, 2007

Related U.S. Application Data
(60) Provisional application No. 60/868,957, filed on Dec. 7, 2006.

(51) Int. Cl. G06F 17/00

(52) U.S. Cl. 463/25

(57) ABSTRACT

This specification relates, in one embodiment, to a system for handling an electronic marker for use at a gaming establishment, such as a casino. The electronic marker can be redeemed using cash or cash equivalents, casino valued currency (such as casino chips) or by the electronic transfer of funds. In certain embodiments, the redemption of the markers is automated such that the markers are automatically redeemed by electronic transfer of funds if they are not manually redeemed within a predetermined period of time.

### CROSS-REFERENCE TO RELATED APPLICATIONS

This application claims priority to and the benefit of co-pending U.S. provisional patent application U.S. Ser. No. 60/868,957, Filed Dec. 22, 2006. The content of the aforementioned application is hereby incorporated by reference into this specification.

### FIELD OF THE INVENTION

This invention relates, in one embodiment, to a system for handling an electronic marker for use at a gaming establishment. Such an electronic marker reduces the burden placed upon the establishment by diminishing the amount of paper that was previously used for such handling.

### BACKGROUND OF THE INVENTION

A marker account is a draft account provided by a gaming establishment that permits an individual to continue to gamble without needing cash. A marker account may be a debit account, wherein the funds are held in escrow by the establishment, or a line of credit extended by the casino. When a person at a gambling table requests an X-dollar marker the pit boss is called to the table. The pit boss records the person's name and then verifies the requestor's account status by contacting the casino cage. The cage operator compares the specified amount (X-dollars) to the available limit (available credit or debit limit) in the account. The request is then approved or declined. If the request is approved, the specified amount is deducted from the available account balance (or credit limit) and the cage operator presents the pit boss with an unsigned voucher for X-dollars. Upon being signed by the requester, the voucher is returned to the cage and the requester is paid in casino chips (or other wagering media) with a total value of X-dollars. The original marker, also referred to as a counter check, is typically kept at the cage or at another secure location.

There are primarily three methods for the requester to redeem the marker. Firstly, the requester of the marker can provide the necessary funds to redeem the voucher outright. For example, the requester can redeem the marker back by providing cash or a personal check for X-dollars. Upon delivery of the requisite funds to the cage operator, the requester is given the original marker. The cage operator typically retains a carbon copy of the original marker to ensure the casino has a complete record of all marker transactions. Secondly, the requester of the marker can redeem the voucher by providing X-dollars in casino currency, such as casino chips. Thirdly, if the voucher was a line of credit, the voucher itself provides the requestor's bank routing number and account number such that the voucher can be cashed like a check. Should the requestor of the marker fail to redeem the voucher within a predetermined time period (typically one to two weeks), then the casino may cash the signed voucher as a check in payment of the outstanding balance. Some casinos will send an invoice to a client prior to cashing the voucher. For example, the casino may send an invoice when the client departs. The client is granted a period for time, for example thirty days, within which to pay the invoice. If the voucher has not been redeemed within thirty one days, then the voucher may be cashed by the casino.

Unfortunately, the aforementioned process is cumbersome, slow and prone to error. If multiple players are requesting markers, the pit boss can only service one such player at a time. The cage operator is likewise limited. Additionally, the extensive paperwork that is generated by the current marker system places a significant burden on the gaming establishment. Redemption of markers is also a time consuming process. Great care must be taken to ensure no vouchers or payments are lost or inappropriately issued. Theft of the original voucher is also a cause for concern.

It would therefore be desirable to provide a system for handling markers which is a substantial improvement over marker management systems. Advantageously, such a system can reduce the use of paper, and thus simplify many financial transactions.

Other electronic gaming systems are known in the prior art which have attempted to address similar problems. Unfortunately, none have proven entirely satisfactory. Reference may be had to U.S. Pat. No. 6,394,907 to Rowe (Cashless Transaction Clearinghouse); U.S. Pat. No. 6,547,131 to Foodman et al. (Preset Amount Electronic Funds Transfer System for Gaming Machines); U.S. Pat. No. 6,739,972 to Flanagan-Parks et al. (Credit System for Gaming Machines and Gaming Tables); U.S. Pat. No. 6,758,393 to Luciano et al. (Mobile Cashier Terminal); U.S. Pat. No. 6,997,807 to Weiss (Cashless Gaming System: Apparatus and Method) and the like.

### SUMMARY OF THE INVENTION

The invention comprises, in one form thereof, a system for handling an electronic marker at a gaming establishment. In one aspect of the invention, the marker is a line of credit secured by a cash account from which funds may be transferred by electronic means, such as EFT or ACH.

### BRIEF DESCRIPTION OF THE DRAWINGS

The present invention is disclosed with reference to the accompanying drawings, wherein:

FIG. 1 is a flow diagram of one process of handling an electronic marker;

FIG. 2 is a flow diagram of a process for requesting an electronic marker;

FIG. 3 is a flow diagram of one process for verifying an electronic marker request;

FIG. 4 is a flow diagram of a process for purchasing an electronic marker;

FIG. 5 is a depiction of one receipt of the present invention; and

FIG. 6 is a depiction of an invoice for use with the present invention.

Corresponding reference characters indicate corresponding parts throughout the several views. The examples set out herein illustrate several embodiments of the invention but should not be construed as limiting the nature or scope of the invention in any manner.

### DETAILED DESCRIPTION

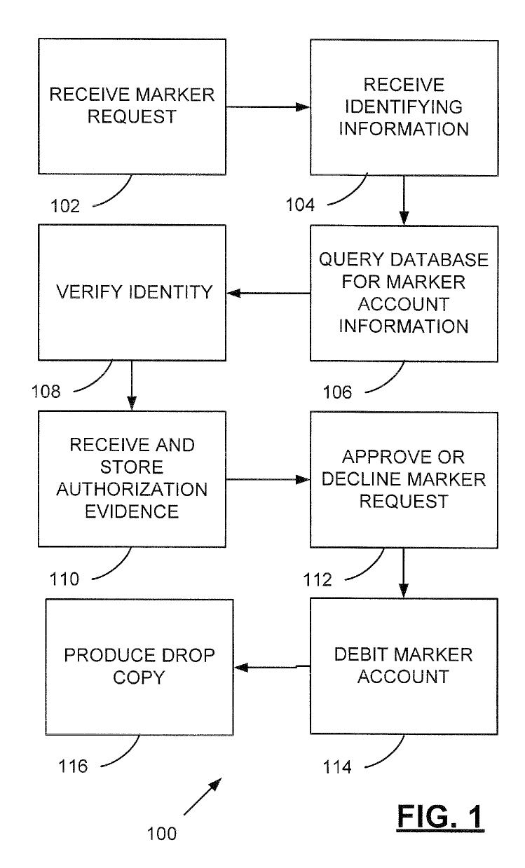

Referring to FIG. 1, process 100 is one process for use with the present invention. Process 100 exemplifies one method for electronically handling a marker. It should be noted that the steps described in FIG. 1 are presented in a certain order so as to more clearly describe the invention. However, the order of such steps may be changed and/or selected steps may be omitted when practicing certain embodiments of the invention. As such, the Figures are merely examples and should not be construed as limiting the invention in any way.

Process 100 is initiated in step 102, wherein a marker request is received. As known by those skilled in the gambling art, a marker is a sight draft against a marker at a gaming establishment, such as a casino. In one embodiment, the draft is against a line of credit previously established by the casino for an individual person or entity. In such an embodiment, drafts against the marker account represent use of the credit. To establish such a line of credit, the requester of the marker account applies to the gaming establishment. A credit check is performed against the background of the requester and an appropriate credit limit is established. In another embodiment, the draft is against a debit account which contains a sum of money deposited with the casino by the individual. In such an embodiment, drafts are taken against such escrowed funds. It is important to note that, in certain aspects of the invention, the issuer of the credit is the gaming establishment itself, rather than a third-party credit source. Third-party credit sources often charge service fees to clients for issuing cash advances. Since, in certain aspects of the invention, the establishment is the issuer of the credit, such establishment can control, or preferably eliminate, such service fees. Once such an account is established, an authorized individual can request markers against such account. One such request is made in step 102.

In step 102 of process 100, the gaming establishment receives a marker request. Such a request may come in the form of a verbal request to a table operator, dealer, casino employee, cage operator, or other agent of the gaming establishment. In another embodiment, such a request comes over a network connection, such as the internet, or through another electronic medium, such as a self-serve electronic terminal. Such network requests are particularly well suited for use with internet-based gaming establishments. Once an establishment is aware of a marker request, the establishment seeks to properly identify if the requestor is authorized to use the account. The establishment requests and receives identifying information from the requester.

In step 104 the establishment receives identifying information concerning the requester of the marker. Such identifying information is comprised of data which can be correlated to a marker account. Such a correlation step may include referring to a database. When the requester is physically present, the identifying information received includes the requestor's physical appearance. In one embodiment, the requester provides a form of electronically readable information, such as a card with a magnetically readable stripe. In another embodiment, the information is stored in digital format in a form that is optically readable, such as a barcode. In yet another embodiment, such information is transmitted using encrypted electromagnetic waves, such as radio waves. Imbedded on such a card is the information necessary to identify the account of the requestor, such as an account number or a primary key. Alternative forms of identification may include a State issued identification card. In another embodiment, the same form of identification also correlates the instant requester to a history of play for such requester. The history of play may include, for example the amount of time spent at a given game, the amount of cash won or lost, the wager activity, and the like. Reference may be had to U.S. Pat. No. 6,951,302 to Potts (System and Method for Performing a Quasi-cash Transaction). In such an embodiment, the requestor's driver's license number, name, or other such information is correlated to an account number by a relational database. In another embodiment, the account number itself is encoded on the card. In yet another embodiment, the requester verbally provides identifying information by giving, for example, a name, account number, telephone number, or the like.

In step 106 of process 100, a database is queried for marker account information based on the information provided by the requester in step 104. Such marker account information preferably includes an identifier such as a digital picture of an individual authorized to use the account and/or a digital picture of such individual's signature. Additionally, such marker account information also includes the credit limit and/or outstanding balance associated with the requestor's account. The marker account information so retrieved also preferably includes the bank routing number and account number for at least one cash account that contains sufficient funds to secure the marker. For example, the bank routing number and account number for a checking or money market account may be contained in the marker account information. After such information is retrieved, one or more identifiers may be displayed to allow the opportunity to verify the identity of the requester. In addition to the identifier(s) being displayed, in some embodiments, certain marker account information is displayed.

In step 108, the identity of the requestor is verified by comparing the identifying information provided by the requester to the identifier that resulted from the query of step 106. For example, the picture of the authorized individual retrieved during step 106 may be displayed and compared to the physical appearance of the requester. Alternatively or additionally, the requestor may be asked to provide a signature, preferably on a touch pad, which is then compared to the digital picture of the signature retrieved in step 106. Other suitable identifiers are also contemplated for use with the present invention. For example, in one embodiment, the identifier is a biometric identifier. As is known to those skilled in the art, biometrics is the science of measuring physical properties of living beings. Examples of biometric data include retinal scans, infrared facial readings, feature spacing, fingerprint scans, and the like. Reference may be had to U.S. Pat. No. 6,935,951 to Paulsen et al. (Electronic Signature Capability in a Gaming Machine); U.S. Pat. No. 7,107,245 to Kowalock (Biometric Gaming Access System); U.S. Pat. No. 7,082,213 to Black (Method for Identity Verification); and the like. Other suitable biometric techniques would become apparent to those skilled in the art after benefiting from reading this specification. Such techniques are considered within the scope of the present invention.

Once the identity of the requester has been verified in step 108, step 110 is executed, wherein the requester authorizes the transaction in accordance with certain terms and the evidence of such authorization is digitally stored by the gaming establishment. In one preferred embodiment, the terms so authorized state that the marker is secured by a certain cash account (specified in the marker account information retrieved in step 106) such that, if the marker is not redeemed within a predetermined period of time, the gaming establishment is authorized to deduct the marker value from the cash account by electronic fund transfer (EFT) in redemption of such marker. In such an embodiment, the marker functions as a secured loan. Methods for performing such EFT are well known in the art. In one embodiment, Automated Clearing House (ACH) software is used. Evidence of the acceptance of such terms by the requestor is preferably stored for later retrieval. Such evidence may be in the form of a signature that is provided on a touch-sensitive screen. In another embodiment, such evidence is in the form of a digitally recorded fingerprint or other digitally recorded biometric data. It is preferred that such evidence be digitally stored on the network and associated with the instant marker request. In one embodiment, the software system of the gaming establishment automatically redeems markers by electronic transfer of funds when a marker reaches the predetermined age. In this manner, little or no personal intervention by a human being is necessary to handle the electronic marker.

In some embodiments, the gaming establishment is provided with an opportunity to approval or decline a marker request. Such an opportunity is provided in step 112. The establishment may choose to decline the marker request for a variety of reasons. In one embodiment, the status of the cash account is checked prior to approving the marker request. If the status is found to be unsatisfactory (the account has a low balance, is closed, etc.) the request may be declined. Alternatively or additionally, the request may be declined because the marker account itself has an insufficient limit left to cover the requested marker. Other reasons for declining the request include the identity of the requester not being verifiable, a note or flag being entered into the marker account information which may indicate a history of problems, or for any other suitable reason. In some embodiments the execution of step 112 is logged to a database. This log may include, for example, the date stamp and timestamp of the request as well as other information pertaining to the request itself. In the embodiment depicted in FIG. 1, such an opportunity to decline follows authorization by the requestor (step 110). In another embodiment, not shown, such an opportunity to decline occurs prior to step 110. In yet another embodiment the data is retrieved (step 106), the identity of the requester is verified (step 108), and the approval decision (step 112) occur at substantially the same time. Should the establishment decide to approve the marker request, then step 114 is executed.

In step 114 of process 100, the desired marker value is deducted from the available limit (e.g. deducted from the credit limit or debited from the escrow funds). The updated limit is then associated with the marker account. In one embodiment, the marker account information, which includes evidence of authorization, current balance, and an itemized history of marker requests, is kept at the gaming establishment solely in electronic form. This account information may also include a time and date stamp that corresponds to the time and date each request was approved. Advantageously, this reduces the dependency upon a paper filing system and printer, thereby decreases the operating expenses of the establishment. As a further advantage, a single invoice can contain an itemized history of multiple marker requests. This is a significant advantage over the prior art. Due to the paper-based nature of prior art marker systems, a carbon copy receipt was generated for each request. A given requestor is likely to make dozens of marker requests during a single visit to the establishment. The volume of paperwork generated in such prior art systems is cumbersome to manage. By providing an single invoice with an itemized history of multiple marker requests, such paperwork is substantially reduced.

In one embodiment, step 116, which is optional, is executed. In step 116, a drop copy is produced for use by the gaming establishment. The drop copy is used by the establishment to help balance the actual currency in the dealer's rack with the expected currency in the rack. In one embodiment, when the drop copy is produced, one or more other departments in the establishment are notified electrically in real time. For example, one or more of the follow departments maybe notified; the accountant, the cashier, the main cage, and the bank cage. In one embodiment, multiple departments are simultaneously notified. Casino currency may be provided to the requester before or after step 116.

Once the marker account has been updated, the requester is provided casino currency whose value is commensurate with the desired marker value. In one embodiment, the items so provided are casino chips and their value is equal to the desired marker value. In another embodiment, the casino chips are provided and a bonus or gift amount is also included as an incentive to induce customers to use the electronic marker system. In one embodiment, such a bonus amount is in the form of additional casino chips. In another embodiment, such a bonus amount is in the form of a gift certificate or other casino credit.

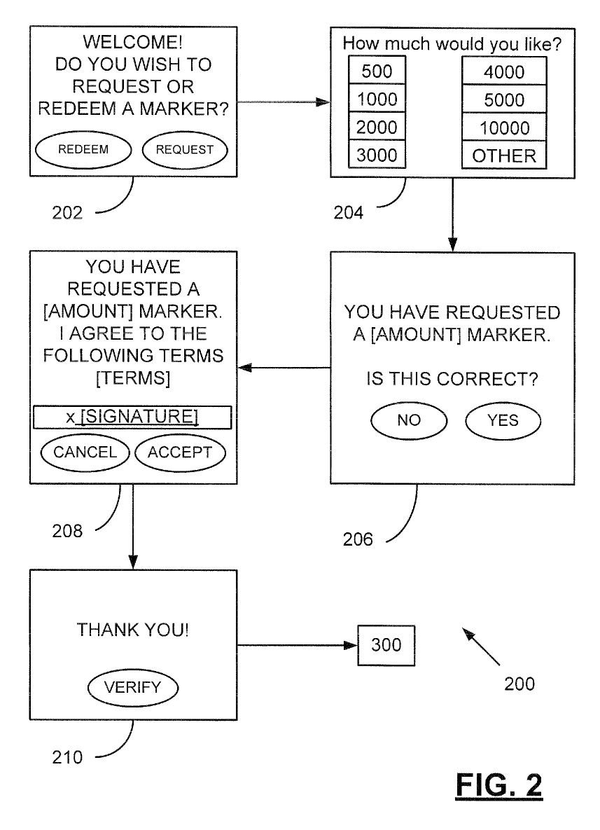

Referring now to FIG. 2, and the process 200 depicted therein, process 200 is a more detailed accounting of certain aspects of process 100 of FIG. 1. It should be recognized that the embodiment depicted in FIG. 2 is only one particular embodiment of one process of the present invention, and there is no intent to limit the invention to such a specific embodiment. Throughout the following example, the requester is assumed to be the individual performing many of the steps indicated. However, other individuals, such as agents of the establishment, may also perform such steps.

Process 200 is initiated when a gaming establishment receives a request to provide a marker. After making such a request, the requester provides identifying information to the gaming establishment. In the embodiment depicted in FIG. 2, the requester provides a magnetic stripe card which is passed through the magnetic stripe reader of an electronic device. Such an electronic device contains software necessary to execute the methods described in this specification. The device is comprised of a digital display and is preferably a hand-held device. Examples of suitable hand-held devices include personal digital assistants (PDA's), tablet computers, and especially tablet computers with touch sensitive screens. In one embodiment, the device is self-contained such that all necessary databases are housed within the device. In another embodiment, the device is connected to a server through a network, wherein such databases are stored, at least in part, on the server. For example, a single server may host a relational database which relates a primary key to account numbers and thus to account information. Several client computers, which are connected to the server through a network, can obtain a primary key (such as a name, account number, telephone number, etc.) from a requester, submit such key to the server, and thus query the database to retrieve the marker account information. In one such embodiment, the connection to the server is a wireless connection. In another embodiment, certain data is stored on the client machines (such as the primary key and an identifier associated with the primary key) and certain other data is stored on the server (such as the primary key and the other marker account information). Such an embodiment advantageously permits the client machines to verify the identity of a requester without utilizing server resources, while securely maintaining the marker account's financial information (such as the account numbers for the cash account) on a secure server. Such a secure server is kept in a location that is difficult for the general public to reach.

Referring again to process 200, in the embodiment depicted in FIG. 2, the identifying information is read by the card reader and screen 202 is displayed. It is preferable that screen 202 be a touch-sensitive screen. The screen 202 may be located on a device disposed at a point-of-sale (such as a gaming table) or at a traditional point of transaction (such as the cage of a casino).

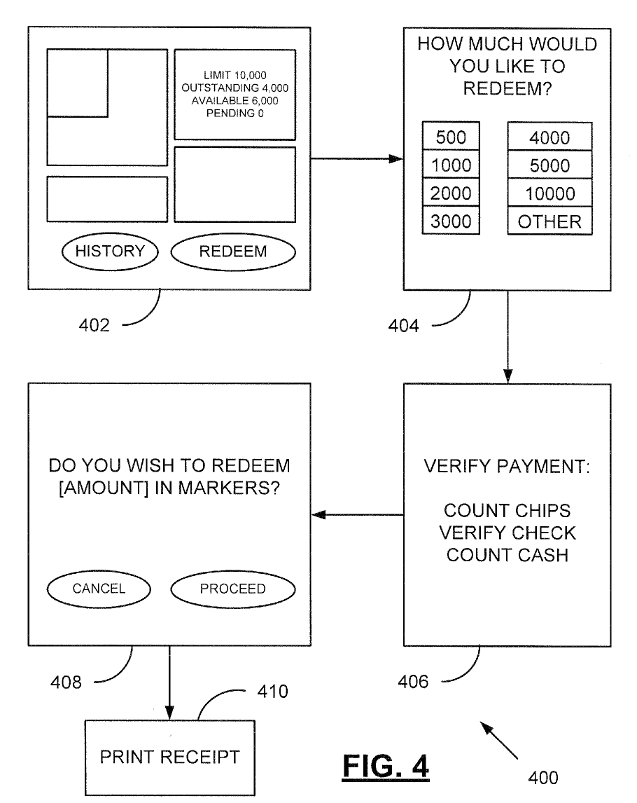

Referring again to screen 202, the requestor of the marker is provided with a welcome screen which asks the requester if he or she would like to request or redeem a marker. If the requester selects “Redeem” then process 400 of FIG. 4 is executed which permits the requestor to buy a marker back. If the requester selects “Request” then screen 204 is displayed that permits the requester to obtain a marker.

Screen 204 prompts the requester to indicate a desired marker value. In the embodiment depicted in screen 204, several predetermined values are presented, such as $500, $1000, $2000, etc. One value, “Other,” which has not been predetermined is also presented. The requester may select one of the predetermined values by pressing the touch-sensitive screen at the appropriate location. In another embodiment, where the screen is not touch-sensitive, the requestor selects the desired value using an input device (not shown) such as a keyboard, keypad, mouse, or similar input device. Should the “Other” value be selected, an additional screen is presented (not shown) wherein the requester can input the desired amount. Once the desired marker value has been selected, the requester confirms the transaction.

In screen 206, which is optional, the device indicates what amount has been requested, thus confirming the selected amount is the desired marker value. The requester is asked to confirm the value (by pressing yes) or declining to proceed (by pressing no). If the requester declines, then screen 202, screen 204, or another suitable screen may be displayed. If the requester confirms the amount is correct, then authorization screen 208 is displayed.

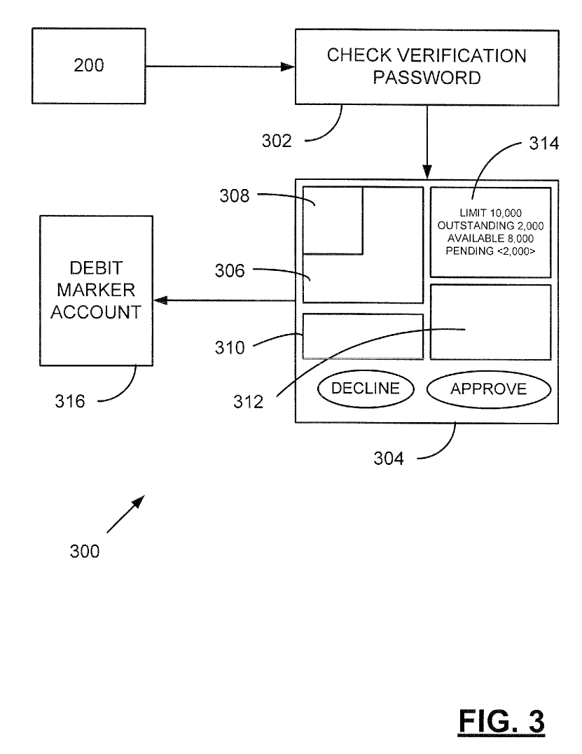

Authorization screen 208 displays the terms of the marker agreement. If the requester declines such terms, then an earlier screen, such as screen 202 or 204, may be displayed and no marker is issued. In the embodiment depicted, the requester accepts such agreement by signing within the signature box on the touch-sensitive screen and thereafter pressing “accept.” This signature is one means for providing evidence of acceptance of the terms of the marker agreement. Such evidence of acceptance is then stored in a digital storage location, such as a network server, or a data storage unit disposed within the device itself. Other methods for providing evidence of acceptance include, but are not limited to, providing a personal identification number (PIN) or other password, or by providing a fingerprint or other biometric data. It is preferred that such evidence be stored digitally. In one embodiment, the signature is digitally stored until the marker is paid. In certain embodiments, the marker is printed with the digital signature displayed thereon. The printing may occur at a secure location, such as the casino cage, casino accounting facility, or other secure location. Once the terms have been authorized, closing screen 210 is shown to the requester. The verification button on screen 210 initiates verification process 300 (see FIG. 3) that is preferably executed by an agent of the gaming establishment.

Referring now to FIG. 3 and verification process 300 depicted therein, process 300 is initiated subsequent to process 200 and begins with the execution of security step 302, wherein a verification password is checked. Certain agents of the gaming establishment know this password. Such a security step, which is optional, helps strengthen the security associated with the verification process by ensuring only authorized personnel can access the marker account information. In one embodiment, such a security step includes receiving both a user name and a password. In such embodiments, the verification system can track which agent of the gaming establishment verified the marker. If the correct password is entered, the device uses the identifying information provided to query a database for the marker account information which is associated with the identifying information. The marker account information is then displayed on screen 304.

Screen 304 of FIG. 3 includes marker account information such as picture 308 which is a digital photograph of an individual authorized to use the associated marker account. Box 306 contains other identifiers such as a name, address, telephone number, account number, and the like. Box 310 contains a digital photograph of a sample of the signature of the individual authorized to use the marker account. Box 312, which is optional, provides additional information such as, for example, the play history of the authorized individual or other notes associated with the account. For example, any security problems the establishment has had with the authorized individual may be listed here. Box 314 contains marker account information such as, for example, account limits (either a credit limit or the debit limit), outstanding balance, available balance, and the current (pending) transaction. Other marker account information includes the routing number and account number of the cash account which secures the marker account. In the embodiment depicted, the gaming establishment can see that the marker account is a line of credit that has $8,000 available credit and a $2,000 marker has been requested. The agent of the gaming establishment can decide to decline the request by pressing “Decline” or proceed with the verification and press “Approved.” If the verification is approved, step 316 is executed wherein the line of credit is debited (the outstanding balance becomes $4,000, the available balance becomes $6,000, and the pending balance becomes $0) and the marker is issued to the requester. The current $2,000 marker is recorded and entered into a transaction history file that is associated with the marker account. Other identifiers that may be displayed in screen 304 include, but are not limited to, biometric data such as fingerprint data. In one such embodiment, a software program compares the digital image of the biometric data to that obtained from the requestor. Such a software program determines if the biometric data so provided matches the biometric data of record in the marker account. Other biometric data which may be stored in the marker account information and used as an identifier, but which need not be displayed, include voice recognition patterns, retinal scans, and similar data wherein a software program performs the comparison, rather than a human being.

FIG. 4 is a depiction of one method 400 for redeeming a marker. Screen 402 is presented when “Redeem” is selected from screen 202 of FIG. 2 after providing identifying information. In one embodiment, not shown, a security step precedes the display of screen 402 to ensure that only an agent of the gaming establishment can access the marker account information shown on screen 402. In yet another embodiment, such a security step ensures that only the authorized individual associated with the account can access the marker account information. For example, the authorized individual may access a marker account over a network, such as the internet. Such individual may choose to redeem the electronic markers through digital means—for example by electronic funds transfer or by credit card payment. In another embodiment, the display of screen 402 is optional. Screen 402 is similar in many respects to screen 304 of FIG. 3, but differs in that the options presented to the user are “History” and “Redeem” rather than “Decline” and “Approve.” If “History” is selected, then an itemized accounting (not shown) of certain past markers associated with the instant account is displayed along with their respective status (e.g. outstanding or redeemed) of each such marker. If “Redeem” is selected, then screen 404 is presented.

Screen 404 of FIG. 4 provides a method to indicate how much should be credited against the outstanding balance of the marker account. In the embodiment depicted in screen 404, several predetermined options are presented, such as $500, $1000, $2000, etc. One option, “Other,” which has not been predetermined, is also presented. The user may select one of the predetermined options by pressing the touch-sensitive screen at the appropriate location. In another embodiment, where the screen is not touch-sensitive, the user selects the desired denomination using an input device (not shown) such as an alphanumeric keyboard, a numeric keypad, a mouse, or similar input device. Should the “Other” option be selected, an additional screen is presented (not shown) wherein the requester can input the desired amount.

In another embodiment of screen 404, not shown, an itemized list of outstanding markers is presented and the user selects which marker is to be redeemed. In one such embodiment, the user is required to redeem the oldest marker first. In another embodiment, the user can select any outstanding marker to redeem. Once the user has selected the amount that is to be redeemed to the account, such an amount is verified in step 406.

In step 406 of method 400, the amount to be redeemed is verified. In one embodiment, an agent of the gaming establishment verifies the amount to be redeemed by, for example, counting the chips or cash provided by the requester, inspecting a check, approving the user of a credit card, or performing an electronic fund transaction using a debit card or similar transaction. In another embodiment, an electronic machine performs verification step 406 by counting tokens using a token counting machine, by reading a card with a magnetic stripe and performing the associated credit, debit, or transfer transaction, or by similar means. Once the redemption has been verified the device presents screen 408, which is optional, to confirm the redemption. The amount to be credited is displayed in confirmation screen 408. In some embodiments, not shown, the payor must provide evidence of authorizing such redemption. For example, when a credit or debit card is used, the user may be required to provide a digital signature on a touch-sensitive pad or PIN before the transaction can be verified and confirmed. Once the transaction is confirmed, the user presses “Proceed” and a receipt of such redemption is generated in step 410, which is optional.

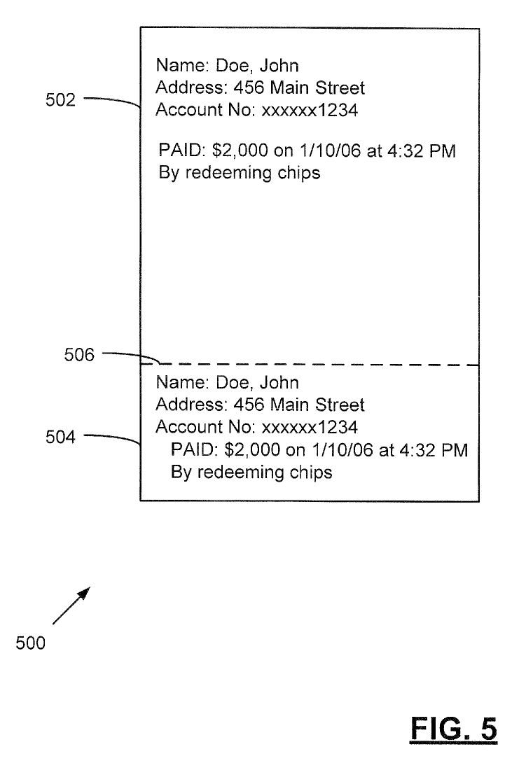

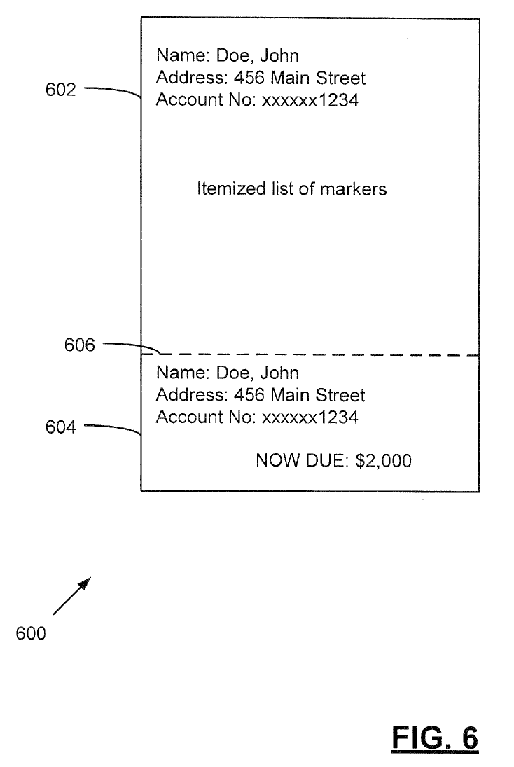

In step 410 a receipt is generated for the payor. One such receipt is illustrated in FIG. 5. Receipt 500 is comprised of a payor record 504 and a payee record 502, separated by perforation 506. In the embodiment depicted in FIG. 5, receipt 500 can be separated by tearing the receipt at perforation 506 and providing payor record 504 to the payor. The payee may retain payee record 502. Receipt 500 contains certain information such as the payor's name, address, the redemption value, the redemption date and the redemption method. In the embodiment depicted, the redemption is made by providing $2,000 in casino chips. In the embodiment depicted, only a partial account number is displayed on the receipt to protect such account. The partial account number may be the account number of the marker account and/or the account number of the account used to redeem the marker (such as a credit card or cash account). In another embodiment, an invoice, rather than a receipt is generated at certain intervals. Such an invoice is depicted in FIG. 6.

In FIG. 6, invoice 600 is shown. Invoice 600 is similar to receipt 500 of FIG. 5, but differs in that an amount due is listed, rather than an amount redeemed. In some embodiments, the gaming establishment will, at certain intervals, generate invoice 600 for certain marker accounts which have non-zero balances. Such invoices can be mailed to the address of record which is associated with the marker account and preferably contain an itemized list of outstanding markers, sorted by the date and time they were verified or requested. In one embodiment, the gaming establishment has been previously authorized to charge outstanding markers to an existing cash account, such as a banking account. In one such embodiment, invoice 600 reflects such redemption having been made. If such redemption was made by electronic funds transfer, the invoice may show a tracking number that is associated with such transfer.

In another embodiment the time interval between invoice cycles and the predetermined time period the establishment will wait before debiting the cash account by electronic transfer are staggered such that the cash account is only debited if the invoice goes unpaid for more than an acceptable period of time.

While the invention has been described with reference to preferred embodiments, it will be understood by those skilled in the art that various changes may be made and equivalents may be substituted for elements thereof to adapt to particular situations without departing from the scope of the invention. Therefore, it is intended that the invention not be limited to the particular embodiments disclosed as the best mode contemplated for carrying out this invention, but that the invention will include all embodiments falling within the scope and spirit of the appended claims.

What is claimed is:

1. A process for handling an electronic marker for use at a gaming establishment comprising the steps of:
a. receiving a marker request from a requestor including a desired marker value,
b. receiving identifying information from the requester,
c. querying a database for marker account information based upon the identifying information from the requester, wherein the marker account information comprises a cash account number, an outstanding balance, and an identifier used to verify the identity of an authorized individual of the marker account,
d. verifying the identity of the requester by comparing the identifier to the identifying information provided by the requester,
e. receiving evidence of authorization to update the marker account from the requester, and thereafter digitally storing the evidence of authorization, wherein the authorization includes terms which authorize the gaming establishment to debit the cash account for an amount equal to the desired marker value if such amount is not redeemed within a predetermined period of time,
f. approving or declining the marker request, wherein if the marker request is approved, issuing chips to the requestor with a total value commensurate with the desired marker value and electronically updating the outstanding balance of the marker account, thus producing an electronic marker,
g. providing an opportunity to redeem the electronic marker, wherein if the electronic marker is not redeemed within a predetermined period of time, the cash account is debited for an amount equal to the desired marker value, thus redeeming the electronic marker and updated the outstanding balance of the marker account.

2. The process as recited in claim 1, wherein the identifier is comprised of a digital picture of the authorized individual.

3. The process as recited in claim 1, wherein the identifier is comprised of a digital picture of the authorized individual's signature.

4. The process as recited in claim 1, wherein the identifier is comprised of a password.

5. The process as recited in claim 1, wherein the identifier is comprised of biometric data.

6. The process as recited in claim 1, wherein the step of receiving identifying information from the requester is comprised of the step of receiving a card from the requester with the identifying information is on the card.

7. The process as recited in claim 6, wherein the identifying information is on a magnetic storage medium on the card.

8. The process as recited in claim 1, wherein said electronic marker can be redeemed using gaming establishment currency.

9. The process as recited in claim 1, wherein the marker account information further comprises an available limit, and wherein the marker request is declined if the desired marker value exceeds the available limit.

10. The process as recited in claim 1, wherein the marker account is a line of credit.

11. The process as recited in claim 1, wherein the marker account is a debit account which holds funds in escrow.

12. The process as recited in claim 1, wherein the step of verifying the identity of the requester includes displaying a digital picture of at least one identifier.

13. A process for handling an electronic marker for use at a gaming establishment comprising the steps of:
a. receiving a marker request from a requester including a desired marker value,
b. receiving identifying information from the requester,
c. receiving a desired marker value from the requester,
d. querying a database for marker account information based upon the identifying information from the requester, wherein the marker account information comprises a cash account number, an outstanding balance, and an identifier used to verify the identity of an authorized individual of the marker account,
e. displaying the identifier such that the identity of the requester can be verified against the identity of the authorized individual of the marker account,
f. receiving evidence of authorization to update the marker account from the requester, and thereafter digitally storing the evidence of authorization, wherein the authorization includes terms which authorize the gaming establishment to debit the cash account for an amount equal to the desired marker value if such amount is not redeemed within a predetermined period of time,
g. approving or declining the marker request, wherein if the marker request is approved, issuing chips to the requestor with a total value commensurate with the desired marker value and electronically updating the outstanding balance of the marker account, thus producing an electronic marker,
h. providing an opportunity to redeem the electronic marker, wherein if the electronic marker is not redeemed within a predetermined period of time, an invoice of the outstanding balance is generated.

14. The process as recited in claim 12, wherein the invoice includes an itemized accounting of the outstanding electronic markers.

15. A process for handling an electronic marker for use at a gaming establishment comprising the steps of:
a. receiving a marker request from a requester including a desired marker value,
b. receiving identifying information from the requestor,
c. querying a database for marker account information based upon the identifying information from the requester, wherein the marker account information comprises a cash account number, an outstanding balance, and an identifier used to verify the identity of an authorized individual of the marker account,
d. displaying the identifier such that the identity of the requester can be verified against the identity of the authorized individual of the marker account,
e. receiving evidence of authorization to update the marker account from the requester, and thereafter digitally storing the evidence of authorization, wherein the authorization includes terms which authorize the gaming establishment to debit the cash account for an amount equal to the desired marker value if such amount is not redeemed within a predetermined period of time,
f. approving or declining the marker request, wherein if the marker request is approved, issuing chips to the requester with a total value commensurate with the desired marker value and electronically updating the outstanding balance of the marker account, thus producing an electronic marker,
g. providing an opportunity to redeem the electronic marker, wherein if the electronic marker is not redeemed within a predetermined period of time, the cash account is debited for an amount equal to the desired marker value, thus redeeming the electronic marker and updating the outstanding balance of the marker account.
